(19) United States
(12) Patent Application Publication
(10) Pub. No.: US 2013/0151517 A1
(43) Pub. Date: Jun. 13, 2013

(54) FILE SEARCH APPARATUS AND METHOD USING TAG GRAPH

(71) Applicant: Electronics and Telecommunications Research In, Daejeon (KR)

(72) Inventors: Jae Sook Cheong, Daejeon (KR); Jong Sung Kim, Daejeon (KR); Do-Won Nam, Daejeon (KR)

(73) Assignee: Electronics and Telecommunications Research Institute, Daejeon (KR)

(21) Appl. No.: 13/708,109

(22) Filed: Dec. 7, 2012

(30) Foreign Application Priority Data
Dec. 7, 2011 (KR) 10-2011-0129998

(51) Int. Cl. G06F 17/30

(52) U.S. Cl. CPC G06F 17/30864
USPC 707/736; 707/769

(57) ABSTRACT

A file search apparatus includes a tag graph storage storing a tag graph. The tag graph includes tag nodes with tag words linked thereto, links/edges between pairs of the tag nodes having association relationships, where each tag node has a list of files tagged with the tag word of the tag node, a list of files attached to each of the tag nodes, such that the files are tagged by the corresponding tag words. A tag word searcher configured to search for the tag nodes containing the words from the user, among all tag nodes of the tag graph. A file searcher configured to search a candidate file, linked to tag words contained the tag nodes searched by the tag word searcher, to determine whether the candidate is a desired file.

### CROSS-REFERENCE TO RELATED APPLICATION(S)

The present invention claims priority of Korean Patent Application No. 10-2011-0129998, filed on Dec. 7, 2011, which is incorporated herein by reference.

### FIELD OF THE INVENTION

The present invention relates to a file search apparatus and method using tag graph, and more particularly, to a file search apparatus and method using tag graph which enables the easy search of the files along a plurality of associated tag nodes.

### BACKGROUND OF THE INVENTION

As computers and networks advance and smart mobile equipments become more common, data that a user needs to manage becomes massive. Currently to access a file, users must know the exact path of the directories of a file, or searches for the desired file with keyword matching in the title or in the body text or in the tag list. This method needs to know an accurate path or keywords.

A conventional method called tag search, which searches a file with keywords (which are not included in the title or body text of the file), for example, associated words, uses tags, a list of words liked to a file and searches for the words in the tags. This method also has the following limitations. First, a user needs to personally input all tag words for each file through a keyboard. Second, there are very often many different words to mean one thing in practice.

Third, when current tag words are listed in one list with no correlation therebetween and when the number of tag words increases, it takes long time to perform a search because all the words in the tags must be checked.

### SUMMARY OF THE INVENTION

In view of the above, the present invention provides a file search apparatus and method that add tags to a file, including various forms of electronic items, into a graph showing an association relationship and thus enable an easy search of a file by following a plurality of associated tag nodes, thereby enabling a user to easily find a desired item or a list of desired items among various electronic items, such as documents, photographs, and video on a computer, even without knowing accurate keywords.

In accordance with a first aspect of the present invention, there is provided a file search apparatus, which includes: a tag graph storage storing a tag graph that includes tag nodes with tag words linked thereto, links/edges between pairs of the tag nodes having association relationships, wherein each tag node has a list of files tagged with the tag word of the tag node, and files, and a link which links the tag node and the file having an association relationship; a tag word searcher configured to navigate along the links of the tag nodes with the tag words related to the association words when a desired file is not found as a file search result using keywords; and a file searcher configured to perform file search using the keywords and listing the files, linked to the tag nodes found in the file search, or chosen by user during navigation in the tag graph.

In the embodiment, the file search apparatus, further includes: a file generator for generating a new file; a tag node link generator for generating a link, linking the new file to a corresponding tag node, to update the tag graph when association words for the new file are included in the tag nodes of the tag graph; and a tag node generator for generating a new tag node and generating a link, linking the new file to the new tag node, to update the tag graph when the association words for the new file are not included in the tag nodes of the tag graph.

In accordance with a second aspect of the present invention, there is provided a file search method using a tag graph, including: performing file search using keywords; enabling user to navigate along the tag nodes with the tag words related to the association words given by the user in a pre-stored tag graph when a desired file is not found; and listing the files, linked to the tag nodes found in the file search, or chosen by user during navigation in the tag graph.

In the embodiment, the file search method further includes: determining, when a new file is generated, whether in the pre-stored tag graph, there are tag nodes which have the association words for the new file as tag words; generating a link, linking the new file to the corresponding tag node, to update the tag graph when there exist, in the tag graph, tag nodes that contain the association words as tag words; and generating a new tag node and generating a link, linking the new file to the new tag node, to update the tag graph when, in the tag graph, there does not exist any tag node that contains the association words for the new file as tag words.

In the embodiment, the file search method further includes: determining whether there is an association relationship between a pair of tag nodes in the tag graph; and additionally generating a link between a pair of tag nodes, determined as having an association relationship, so that the tag graph represents association relationship between the tag words.

### BRIEF DESCRIPTION OF THE DRAWINGS

The above and other objects and features of the present invention will become apparent from the following description of embodiments given in conjunction with the accompanying drawings, in which:

FIG. 1 is a tag graph showing an example of a set of files, the tag words for each file, and association relationship between the tag words, in accordance with an embodiment of the present invention;

FIG. 2 is a tag graph showing an example in which a new file is generated and tagged, and the tag graph in FIG. 1 is updated accordingly, in accordance with an embodiment of the present invention;

FIG. 3 is a block diagram illustrating how a file search apparatus using tag graph works in accordance with an embodiment of the present invention;

FIG. 4 is a flowchart describing an operation that tags a new file using a tag graph when a new file is generated, in accordance with an embodiment of the present invention; and

FIG. 5 is a flowchart describing an operation that finds a file by navigating the tag graph when a user cannot find a desired file with keywords, in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

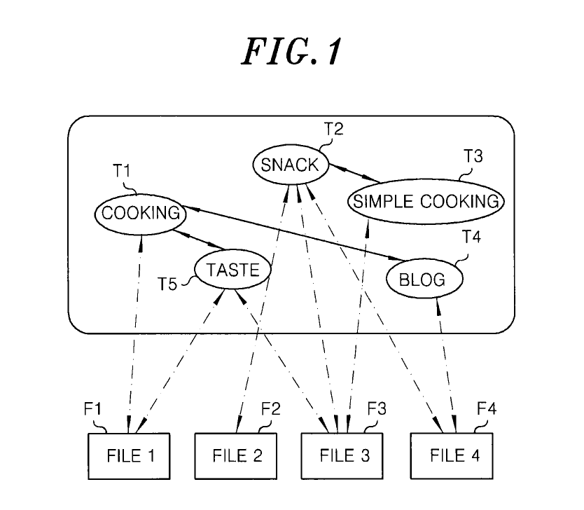

FIG. 1 is a tag graph showing an example of a set of files, the tag words for each file, and association relationship between the tag words, in accordance with an embodiment of the present invention.

In FIG. 1, the tag graph includes a plurality of tag nodes T1 to T5 that contain tag words such as “cooking”, “snack”, “simple cooking”, “blog”, and “taste”, respectively. FIG. 1 shows an embodiment including a file 1 (F1), a file 2 (F2), a file 3 (F3), and a file 4 (F4).

In FIG. 1, dotted lines represent links between the tag nodes T1 to T5 and the files F1 to F4, and solid lines represent links between pairs of tag nodes with association relationships. Here, the links represented by dotted and solid lines are bidirectional. That is, a tag node can be accessed from its linked files, a file from its linked tag nodes, and a tag node from its neighbor tag nodes. The links may be manually formed by a user, or automatically formed by defining an association relationship in a system. It is not required to connect all the nodes in the tag graph.

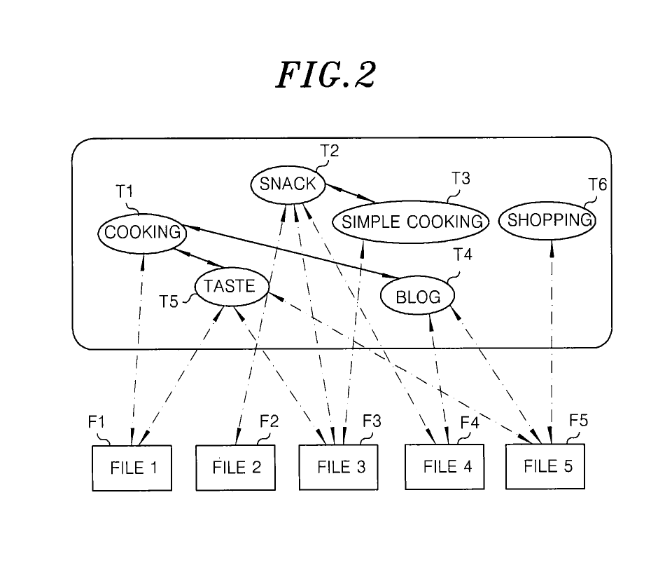

FIG. 2 shows an example of a tag graph in which a new file is generated and tagged, and the tag graph in FIG. 1 is updated accordingly, in accordance with an embodiment of the present invention.

According to an embodiment of FIG. 2, a new file F5 is tagged to the tag words contained in the existing tag nodes T4 and T5, and thus the new file F5 is linked to the tag nodes T4 and T5. When adding a new tag word to the new file F5 and when the new tag word is not contained in the existing tag nodes T1 to T5, a new tag node T6 is generated, and linked to the new file F5. When the tag node T6 has an association relationship with some existing tag nodes in the tag graph, a user may add a link manually. Also, when there is an algorithm or a rule that enables a system to decide that there is an association relationship between two tag nodes, the system may automatically add a link.

For example, in FIG. 2 showing one exemplary case in which there exist tag words “blog” and “taste” related to the new file F5 and thus the tag words “blog” and “taste” are linked to their respectively corresponding nodes T4 and T5; and when a tag word “shopping” is related to the new file F5 but is not contained in any tag nodes, a new tag node T6 containing the tag word “shopping” is generated.

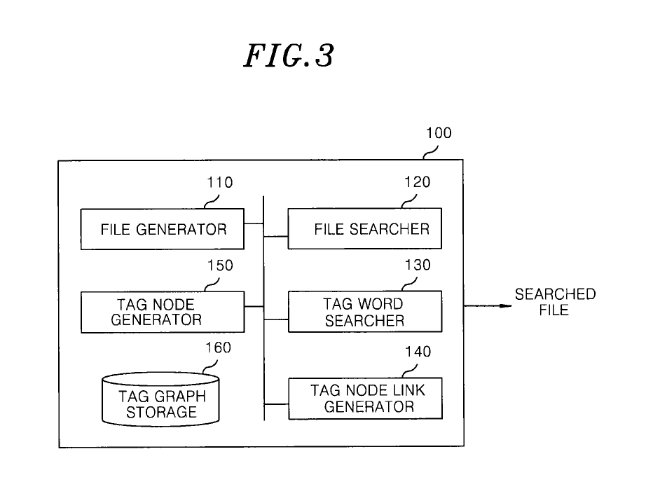

FIG. 3 is a block diagram of a file search apparatus in accordance with an embodiment of the present invention.

As illustrated in FIG. 3, a file search apparatus 100 includes a file generator 110, a file searcher 120, a tag word searcher 130, a tag node link generator 140, a tag node generator 150, and a tag graph storage 160.

The tag graph storage 160 stores a tag graph. The tag graph includes tag nodes with tag words linked thereto, and files, wherein each tag node has a list of files tagged with the tag word contained in the tag node. Further, there are links/edges between pairs of the tag nodes having association relationships, wherein a link links the tag node and the file having an association relationship.

The tag word searcher 130 searches for the tag nodes containing the words provided from the user, among all tag nodes in the tag graph when a desired file is not found as a file search result with keywords.

The file searcher 120 performs file search using keywords and searches the list of files linked to the tag nodes searched by the tag word searcher 130, thereby determining whether there is a desired file among the file list.

The file generator 110 generates a new file.

The tag node link generator 140 generates a new tag node when the association words for the new file are contained in the tag nodes in the tag graph, and then generates a link that links the new file to the new tag node, thereby updating the tag graph.

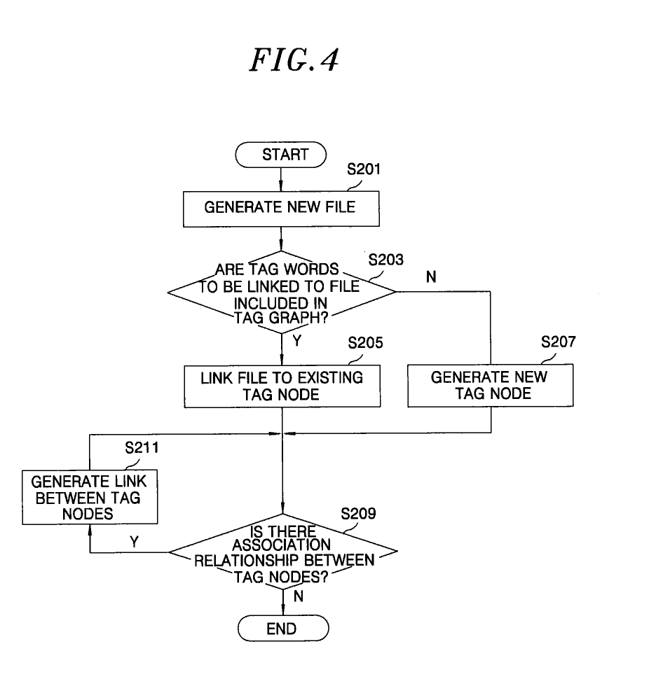

FIG. 4 is a flowchart describing an operation that tags a new file by using a tag graph when the new file is generated, in accordance with an embodiment of the present invention.

Referring to FIG. 4, a file search method in accordance with an embodiment of the present invention includes: operations S201 and S203 that determines, when a new file is generated, whether association words for the new file are included in tag nodes stored in a tag graph storage; operation S205 that generates a link, linking the new file to a corresponding tag node, to update the tag graph when the association words for the new file are included in the tag nodes; operation S207 that generates a new tag node and then generates a link, linking the new file to the new tag node, to update the tag graph when the association words for the new file are not included in the tag nodes; operation S209 that determines whether there is an association relationship between the tag nodes in the tag graph; and operation S211 that additionally generates a link between the tag nodes, which are determined as having the association relationship, to update the tag graph.

An operation, in which the file search apparatus generates a file and adds a link, will now be described with reference to FIGS. 3 and 4.

First, when the file generator 110 generates a new file in operation S201, the tag word searcher 130 determines whether association words for the new file, namely, tag words to be linked to the new file are contained in the existing tag node in a tag graph, in operation S203.

When it is determined that the tag words to be linked to the new file are contained in the existing tag node in the tag graph, the tag node link generator 140 links the new file to the existing tag node in operation S205.

However, when it is determined that the tag words to be linked to the new file are not contained in the existing tag nodes in the tag graph, the tag node generator 150 generates a new tag node, and the tag node link generator 140 links the new file to the new tag node in operation S207.

Subsequently, the tag node link generator 140 determines whether there is an association relationship between the tag nodes in the tag graph in operation S209. When it is determined that there is an association relationship between the tag nodes, the tag node link generator 140 additionally generates links between the tag nodes in operation S221. An operation of generating the links is repeatedly performed until there is no association relationship between the tag nodes.

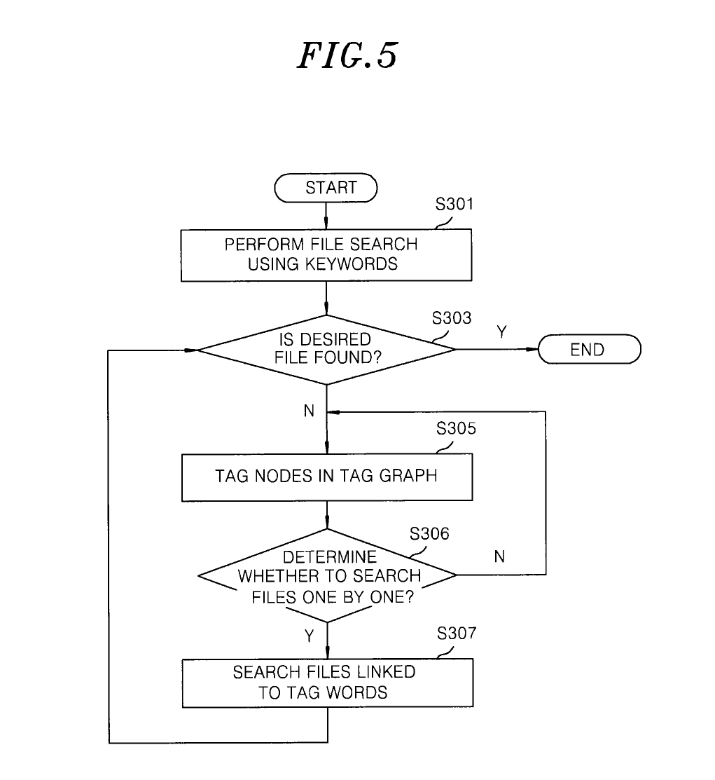

FIG. 5 is a flowchart describing an operation that finds a file by navigating the tag graph when a user cannot find a desired file with keywords, in accordance with an embodiment of the present invention.

Referring to FIG. 5, a file search method in accordance with an embodiment of the present invention includes: operation S301 that performs file search using keywords; operation S303 that search tag nodes containing tag words related to association words when a desired file is not found as the file search result; and operations S306 and S307 that search a list of files, linked to the searched tag words, to determine whether there is a desired file when intending to search files linked to the searched tag nodes one by one.

An operation, in which the file search apparatus searches for files, will now be described with reference to FIGS. 3 and 5.

First, the file searcher 120 performs file search using keywords in operation S301. When a desired file is not found even performing the file search using keywords, the file searcher 120 notifies the tag word searcher 130 that the desired file is not found, in operation S303. Further, when long search time is necessary because there are too many linked files which are targeted for file search, the file searcher 120 may notify the tag word searcher 130 that long search time is necessary.

The tag word searcher 130 searches for tag nodes containing the tag words provided from a user, among the tag nodes in the tag graph stored in the tag graph storage 160, in operation S305. In this way, performing operation S305 is for reducing a search range.

Subsequently, the file searcher 120 determines whether to search a list of files linked to the tag nodes searched by the tag word searcher 130 one by one, in operation S306. According to the determined result, the file searcher 120 again performs operation S305, or searches the list of files linked to a tag node containing the tag words, to determine whether a desired file is founded in operation S307.

Such search operations S305 and S307 are repeatedly performed until the desired file is found.

According to the embodiments of the present invention, when tag words of a user have a correlation therebetween, by drawing a link, the user can easily determine and manipulate a relationship between tags while looking at a graph.

Moreover, a user may perform work while looking at the degree of relation between the existing tags through a graph, and thus, a probability that tag words are overlapped and tag words related to a file are omitted is relatively lower than a conventional tagging method.

Moreover, in searching a file, even though a user cannot know accurate information (which is recorded in a computer) such as a file name, a storage location, words of the body text, and time, the user can search tag words by following the degree of association/relation.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A file search apparatus comprising:
a tag graph storage storing a tag graph, wherein the tag graph includes tag nodes with tag words linked thereto, wherein each tag node has a list of files tagged with the tag word contained in the tag node;
a tag word searcher configured to search for tag nodes containing tag words provided from the user, among all tag nodes in the tag graph; and
a file searcher configured to search a list of files linked to the tag nodes searched by the tag word searcher, to determine whether a desired file is founded among the list of files.

2. The file search apparatus of claim 1, further comprising:
a file generator configured to generate a new file;
a file link generator configured to generate a link, linking the new file to the tag nodes in the tag graph when association words for the new file are contained in the tag nodes in the tag graph, to update the tag graph; and
a tag node generator configured to generate a new tag node and link the new file to the new tag node when association words for the new file are not contained in the tag nodes in the tag graph, to update the tag graph with the new tag node.

3. A file search method comprising:
performing file search using keyword matching;
searching tag nodes in a tag graph stored in a tag graph storage when a desired file is not found as a result of the file search; and
searching a list of files, linked to the searched tag nodes, to determine whether a desired file is founded from the list of files.

4. The file search method of claim 3, further comprising:
determining, when a new file is generated, whether association words for the new file are included in the tag nodes of the tag graph;
generating a link, linking the new file to corresponding tag nodes, to update the tag graph when the association words for the new file has some corresponding tag nodes in the tag graph;
generating a new tag node when the association words for the new file are not contained in the tag nodes in the tag graph; and
generating a link, linking the new file to the new tag node, to update the tag graph.

5. The file search method of claim 4, further comprising:
determining whether there is association relationship between the tag nodes in the tag graph; and
additionally generating a link between tag nodes, determined as having the association relationship, to update the tag graph.
